(19) United States
(12) Patent Application Publication
(10) Pub. No.: US 2023/0081488 A1
(43) Pub. Date: Mar. 16, 2023

(54) METHODS AND SYSTEMS FOR ENABLING MICRO INTERACTIONS AND TRANSACTIONS ON FIAT, CRYPTO AND NFT FOR MULTIMEDIA

(71) Applicants: VIGNESH RAMASWAMY, TRIVANDRUM (IN); MADHAN KARKY, CHENNAI (IN)

(72) Inventors: VIGNESH RAMASWAMY, TRIVANDRUM (IN); MADHAN KARKY, CHENNAI (IN)

(21) Appl. No.: 17/583,205

(22) Filed: Jan. 25, 2022

Related U.S. Application Data
(60) Provisional application No. 63/243,100, filed on Sep. 11, 2021.

(51) Int. Cl. G06Q 20/02; G06Q 20/38; G06Q 20/36

(52) U.S. Cl. CPC G06Q 20/027; G06Q 20/389; G06Q 20/3678

(57) ABSTRACT

A computerized method of a canvas system comprising: providing the canvas system, wherein the canvas system comprises a multimedia media content tool/platform that provides a set of functionalities of a user interface; providing a set of canvas-system based media content; organizing the canvas-system based media content in a plurality of blocks, wherein each block comprises a set of digital assets on a block level with a set of specified integrations and engagements; with the plurality of blocks: provide a set of block-level interactions, nest one block into another, put a block behind a paywall (e.g. as a fiat/crypto currency or as an NFT, etc.), visually represent the blocks in different parts of the block, create relations between a set of different blocks, add one or more tags to each block, and enable one or more micro-interactions/transactions for the canvas-system based media content among a plurality of users.

### CLAIM OF PRIORITY

This application claims priority to U.S. Provisional Patent Application No. 63/243,100, filed on 11 Sep. 2021. This Provisional Patent Application is hereby incorporated by reference in its entirety.

### BACKGROUND

Identity is not static. It can arise from a cyclical interaction of three key elements of the creative process. These can include: creation, monetization, and discovery. In this way, the act of creating can not be separated from monetizing. For example, monetizing is connected to discovery, and discovery leads to creation. In a way, life is a creator's canvas. Therefore all forms of creation should be presented and engaged with and the creator should have control over the life potential of their creation. The creator should decide with whom and how to bring their creations to reach their potential. Creative enterprises should be able to work with creators without conflict. Creation, storage, monetization, and discovery should happen in the same place as well.

Today's creator is often disembodied. They take different aspects of themselves to different digital applications. Their creation should not be restricted to one particular domain of discovery. At the same time, the opportunities for creation and monetization of creations are increasing. For example, creators can leverage fiat, crypto and NFT technologies to monetize their multimedia creations on the Internet. Accordingly, improvements to the methods and systems of how creators create, store, monetize, and enable the discovery of the multimedia creations on the Internet are desired. These improvements can include an editor tool which allows micro interactions as to how ow creators create, store, monetize, and enable the discovery of the multimedia creations as well.

### SUMMARY OF THE INVENTION

A computerized method of a canvas system comprising: providing the canvas system, wherein the canvas system comprises a multimedia media content tool/platform that provides a set of functionalities of a user interface; providing a set of canvas-system based media content; organizing the canvas-system based media content in a plurality of blocks, wherein each block comprises a set of digital assets on a block level with a set of specified integrations and engagements; with the plurality of blocks: provide a set of block-level interactions, nest one block into another, put a block behind a paywall (e.g. as a fiat/crypto currency or as an NFT, etc.), visually represent the blocks in different parts of the block, create relations between a set of different blocks, add one or more tags to each block, and enable one or more micro-interactions/transactions for the canvas-system based media content among a plurality of users.

### BRIEF DESCRIPTION OF THE DRAWINGS

The present application can be best understood by reference to the following description taken in conjunction with the accompanying figures, in which like parts may be referred to by like numerals.

FIG. 1 illustrates an example Canvas system, according to some embodiments.

FIG. 2 illustrates an example Block process, according to some embodiments.

FIG. 3 illustrates an example schematic view of a Block structure, according to some embodiments.

FIGS. 4 and 5 illustrates an example landing page attributes, according to some embodiments.

FIG. 6 illustrates an example tool kit GUI, according to some embodiments.

FIG. 7 illustrates an example monetization page, according to some embodiments.

FIG. 8 depicts an exemplary computing system that can be configured to perform any one of the processes provided herein.

FIG. 9 illustrates an example process for implementing online multi-media micro transactions, interactions and monetizations, according to some embodiments.

FIGS. 10-19 illustrate example screenshots of various canvas creation steps, according to some embodiments.

The Figures described above are a representative set and are not an exhaustive with respect to embodying the invention.

### DESCRIPTION

Disclosed are a system, method, and article of manufacture for enabling micro interactions and transactions on fiat, crypto and NFT for multimedia. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Block can be a text word, text paragraph, pixels, audio (e.g. in terms of seconds, minutes, etc.), image (e.g. in terms of pixels), video (e.g. in terms of seconds, minutes, etc.), various multimedia files, etc. Each block can be pushed as fiat currency interaction or as an NFT interaction or as a crypto currency interaction. Blocks can also be micro-interactions in an augmented/virtual reality space too. Blocks can be arranged in parent/child hierarchies. For example, a same block and whole interaction can be done on a parent block or a child block or both. A block can include a set of digital assets on a block level (e.g. word, paragraph, second, pixel, etc.), integrations and engagements. The Block can be used to implement, inter alia: nest one block into another; put a block behind a paywall (e.g. both fiat and crypto); visually represent the blocks in different parts of the canvas; create relations between different blocks; add tags to each block; optional comments, comments under a paywall and reply to threads for different blocks; etc.

Canvas can be a block interaction system on any multimedia. A canvas can comprise a plurality of blocks. A canvas can be used in a creator's webpage space and/or extended to other type of multimedia platforms. These can include virtual-reality spaces, etc. Interactions with canvas elements can be beyond the block level as well. Canvas can include, inter alia:
block level interactions on any type of content;
system for a decentralized, blockchain powered gamification which provides value for the time spent by a creator and consumer for the process of creation and consumption respectively;
a new community currency which will redefine and create a living breathing economy for creators; and
the economic principles of this currency would be driven by it's unique interactions (both offline and online) between a creator and consumer. It is noted that a user can add any hyperlink on the Internet inside a canvas as a block. The user can then implement the same block interactions as defined thereto.

Non-fungible token (NFT) is a unit of data stored on a digital ledger, called a blockchain, that certifies a digital asset to be unique and therefore not interchangeable. NFTs can be used to represent items such as photos, videos, audio, and other types of digital files. Access to any copy of the original file, however, is not restricted to the buyer of the NFT.

### Example Systems And Methods

The following are discussed:
Live/Simultaneous collaboration between creators;
Lock any form of content (Audio, Video, Written) very specifically (e.g.: If it's a 30 mins video, as a creator, they will be able to put last x minutes under the paywall (both fiat and crypto) and as a consumer, when someone reach x mins, they can watch the rest post making the purchase/interaction); and

Payment Split (when collaboration happens between Creator 1 and Creator 2, the main collaborator should be able to edit the % split).

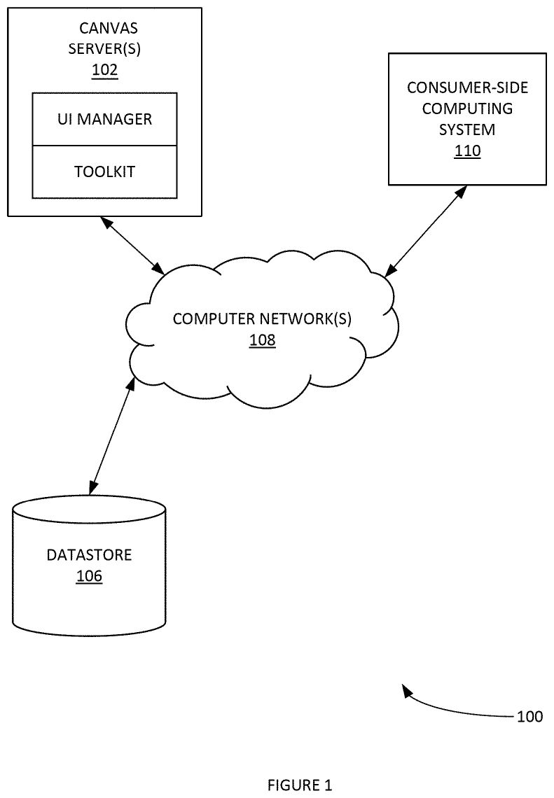

FIG. 1 illustrates an example Canvas system 100, according to some embodiments. Canvas system 100 can provide a Canvas for creation, monetization, and discovery. A Canvas system/interface can provide the functionalities of a user interface and the data layer through a linear blockchain ledger and a multi model database. As discussed infra, the user interface can be dynamic, evolving, and intuitive. The Canvas UI can provide a high bandwidth and high-fidelity interface to seamlessly transfer a user's thoughts, ideas, and concepts between a creator (e.g. the user) and one or more consumers. Likewise, Canvas system 100 can enable frictionless micro transactions of content and/or engagement. The user can invent news ways to engage with consumers using the Canvas tools. The Canvas can provide a normalized block chain powered gamified discovery engine that uses an in-app currency for interaction based redeemable rewards as well. Creators/User can structure their content/work/expertise the way they want. For example, a creator can think of monetization before discovery. Canvas system 100 can utilize various media formats such as, inter alia: text, audio, video, visual, AR/VR, performance-based content, etc.

Canvas system 100 can also enable collaboration by providing multiple modes for creators to collaborate real time with other creators and even consumers in-app through engagements, content, and integrations. Canvas system 100 can be a content centric modular environment that allows users of all kinds to extract value out of content while protecting the creators interests. Canvas system 100 can provide a modular user interface that provides complete freedom for creators to structure their content/work/expertise.

Canvas system 100 can utilize a relational hierarchy of contents. This content can mimic a mental model of the creator/user enabling consumers to navigate and absorb the content in the most efficient way possible. This can provide new ways for consumers to interact with the creator and their creation and visualize it in a more robust and intuitive way. This can ensure that value is provided for the time spent by creators and consumers for creation and consumption respectively, thereby powering the creative economy.

In some example embodiments, Canvas system 100 can be utilize an SSR react application with dynamic routing and progressive hydration. A backend can be a mix of Microservices and Serverless functions that interfaces with a NoSQL and/or an RDBMS. All of these will be set up with CI/CD and auto scaling by default. Canvas system 100 can be optimized for scale and development speed. Canvas system 100 can use different kinds of databases that are the best fitting for the specified use cases and use an amalgamation of all of these to get the best performance at scale while still being cost-effective. Canvas system 100 can use a next.js and/or blitz.js based frontend. The SSR be used to increase application speed and dynamic routing. Canvas system 100 can replicate specified data model(s) as the frontend data blocks can use a NoSQL DB (e.g. MongoDB). Canvas system 100 can also use an RDBMS (e.g. with a GraphQL layer).

Canvas system 100 can utilize various microservices system for different APIs. The microservices can utilized various frameworks. The microservices can be containerized and support frictionless porting.

Canvas system 100 can provide a landing page. The landing page can provide an inline and modular view for the creator post sign up. The creation block can include an editor with style options (e.g. bold/italic/underline, bullets, fonts, highlights, headlines, links, upload image/audio/video, etc.). The landing page can provide various embed link options. Each style mentioned (e.g. in headlines, cover images, etc.) can be represented as individual Blocks. Additionally, Canvas Integrations can be provided.

For a monetization block, a paywall can be maintained. Interaction for content with consumers can be provided. Creators can be provided other filter/public-private-closed toggle functions on the landing page as well. Pay walls can be implemented with a fiat currency/multiple currencies plus an NFT interaction. In some examples, crypto currencies and block chain networks can be utilized to provide payments.

In some embodiments, Canvas system 100 can enable a user to login into a creation space. The creation space can also provide a toolkit dashboard. An application store can be provided. This can provide access to various content on the Internet for integration into a Canvas. For example, a user/creator can integrate YouTube® videos, WordPress® content, MailChimp®, etc. into a Canvas. Canvas system 100 can enable a user to co-create a Canvas content as well. Canvas system 100 can enable searches for other co-creators. Co-creators can split payment on content that is built using a canvas tool. Canvas system 100 can enable users to create and manage Blocks. Canvas system 100 can enable the building and management of modular Blocks in the canvas or a sub-canvas.

In one example, a canvas can be a newsletter created simply few a click(s). Canvas system 100 can then handle the backend. Each monthly newsletter can be a sub-canvas. The canvas and the sub-canvas can be in a parent-child hierarchal relationship. The user can sell any block of content (even to the granular text level) via a paywall. Some content can be behind a pay block and other content can be free.

Canvas system 100 can enable users to create engagements. An engagement can include a payment/subscription detail, block/content involved, calendaring, etc. This can all be selected with the click of a few button via the canvas interface. Users can add and/or otherwise update engagements as well. Users can block media, paragraphs, etc. in play blocks. User's can be for the full engagement or sub-elements thereof. This can open up new monetization avenues for user at a more granular level of content. Canvas system 100 can enable adding an NFT to a canvas. With a click of a button a user can create an NFT. Any block can be selected for an NFT. Even a portion of a block can be selected for an NFT.

Canvas system 100 can manage and provide a creation tool functionality for NFT related media content. This can be used to package an NFT on a block level. Canvas system 100 can support work by artist, script writers, etc. as use cases. Canvas system 100 supports pay block and NFT blocks as part of its monetization modalities. Every action on a creator's content can be equated to a value.

More specifically, FIG. 1 shows a Canvas server 102. Canvas server 102 can communicate with consumer-side computing systems 110 via computer network(s) 108. Datastore 106 can be used to store the Canvases, blocks, NFT information, etc.

Canvas system 100 can manage a discovery system. The discovery system can be a normalized, decentralized discovery system. Creators can define if they want to be part of the discovery system and their level of expertise in the discovery system. The value can be converted into a creator currency as part of the normalized discovery system. Plus or minus signs can be used to designated good or bad content.

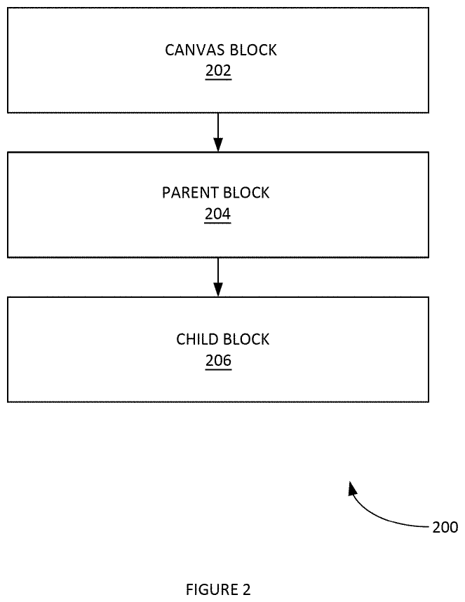

FIG. 2 illustrates an example Block process 200, according to some embodiments. As noted supra, Canvas system 100 can utilize Blocks 202. Block 202 includes a set of digital assets, integrations, and engagements. Block 202 is a discreet unit of content. Block 202 can be used to perform various actions. These actions can include, inter alia: nest one Block 202 into another; place a Block 202 behind a paywall; visually represent a set of Blocks 202 in different parts of a Canvas; create relations between different Blocks 202; add tags to each Block 202; provide optional comments and reply to threads for different Blocks 202; etc. As shown, Block 202 can be found on a user homepage. Block 202 can have a Parent block 204 and/or Child block 206.

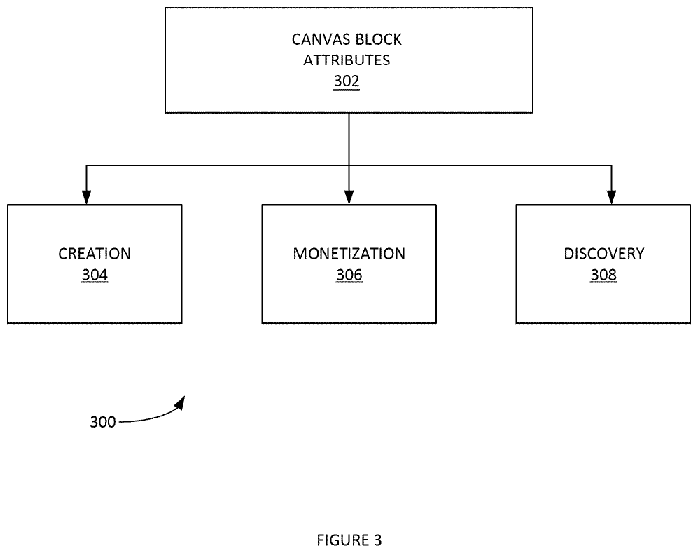

FIG. 3 illustrates an example schematic view of a Block structure 300, according to some embodiments. Various Block attributes 302 can be provided. Creation attributes 304 can be a Block attribute. Creation attributes 304 can include a text-based Block that enables creators to edit long format text-based posts, articles, books, etc. using intuitive text formatting tools. Creation attributes 304 can be a Canvas Image, Video, and Audio blocks. These can enable creators to upload and embed this kind of file with inline previews for the creators and consumers. Creators can set up communities to interact with other creators and/or followers. These communities can also be automatically created upon purchase or subscription. Creators can integrate popular existing tools and platforms to showcase/cross post their work on a Canvas as well.

Monetization attributes 304 can be provided. Creators granularly select the exact piece of content they want to put behind a paywall using the Blocks. Any nested blocks/content can also be unlocked if the parent/root block is unlocked. The creators can separately offer the nested blocks as individual purchases. International transactions can be supported from the get-go using stripe. Creators can setup up multi-tier paywall for the same content using early access, downloads, and any other type of engagement. Creators can also setup fees for Engagement blocks like a one-on-one call, live stream/sessions, consultation, and collaboration.

Discovery attributes 306 can be provided. Discovery can include granular search with filtration and sorting based on time, genre, tags, type of content, etc. Separate showcases can be provided to different types of content. A cluster of Blocks can be displayed in a gallery, carousel, 3D space, etc. A currency-based gamification system can be provided as well in a Canvas discovery engine. Additionally, various search functionalities (e.g. image search, Internet search, self database search, etc.) can be provided.

### Example User Interfaces

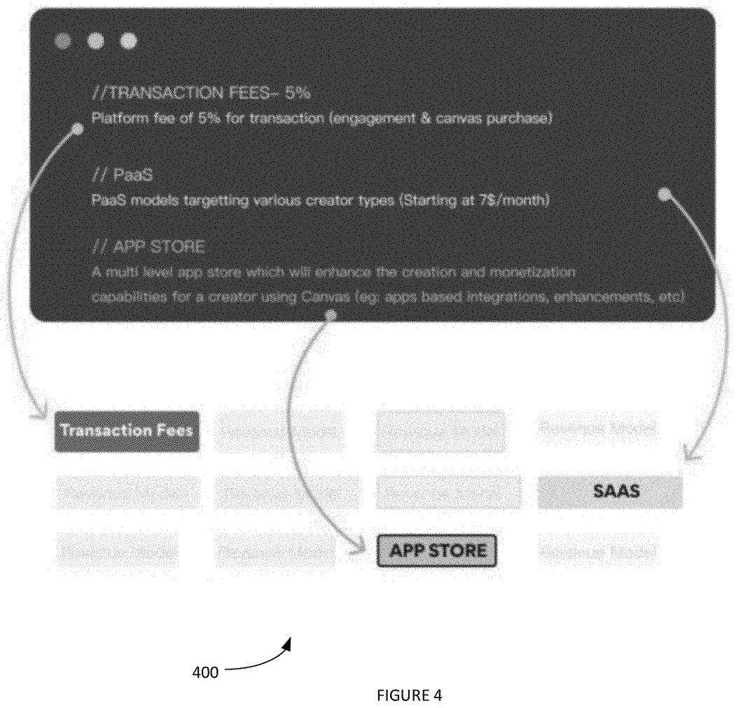

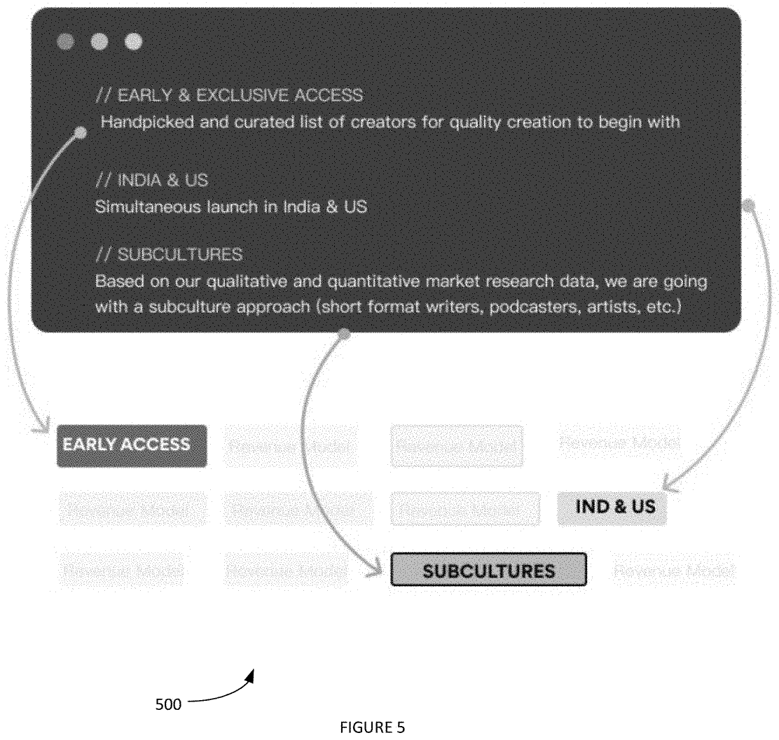

A set of Canvas user interfaces are now provided. FIGS. 4 and 5 illustrates an example landing page attributes 400 and 500, according to some embodiments.

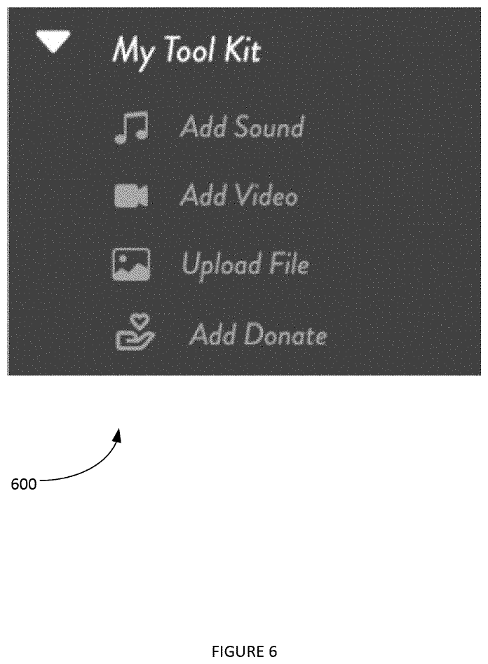

FIG. 6 illustrates an example tool kit GUI 600, according to some embodiments. The tool kit can be used to add, import, and embed rich content including, inter alia: audio, videos, images, pdfs, etc. This can be done in-line on the user's canvas. When a user takes an action on the canvas the Canvas system 100 manages the technical backend of the operations automatically.

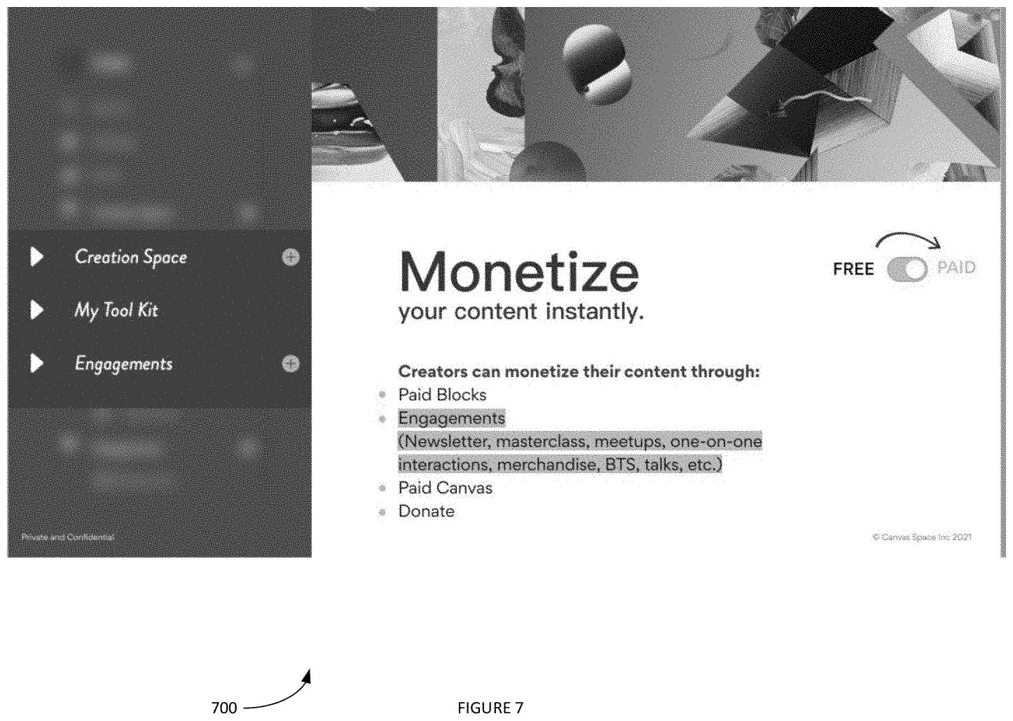

FIG. 7 illustrates an example monetization page 700, according to some embodiments. As shown, the user can toggle between free and paid content generation and/or management.

### Additional Computing Systems

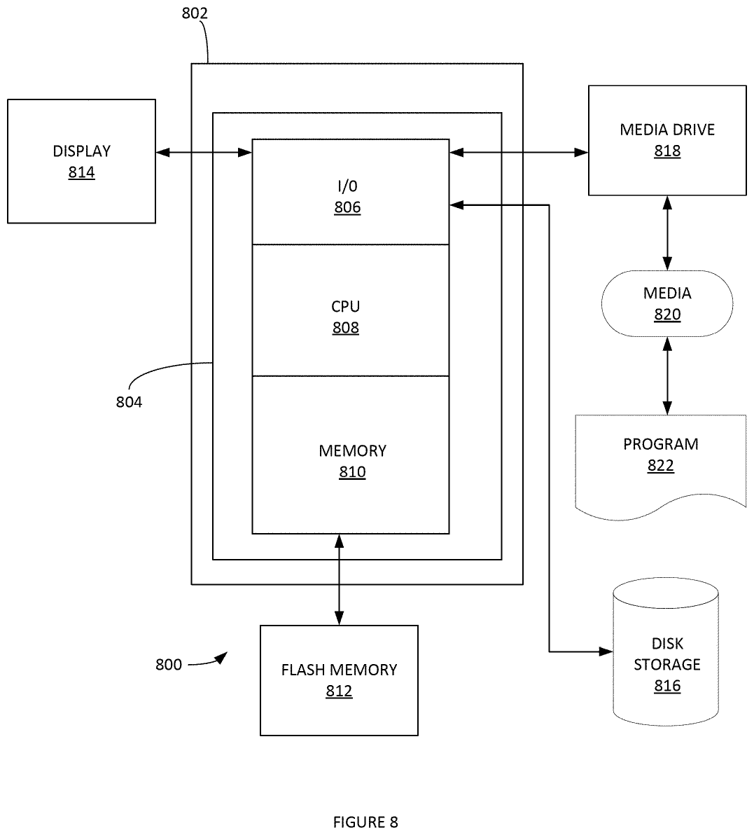

FIG. 8 depicts an exemplary computing system 800 that can be configured to perform any one of the processes provided herein. In this context, computing system 800 may include, for example, a processor, memory, storage, and I/O devices (e.g., monitor, keyboard, disk drive, Internet connection, etc.). However, computing system 800 may include circuitry or other specialized hardware for carrying out some or all aspects of the processes. In some operational settings, computing system 800 may be configured as a system that includes one or more units, each of which is configured to carry out some aspects of the processes either in software, hardware, or some combination thereof.

FIG. 8 depicts computing system 800 with a number of components that may be used to perform any of the processes described herein. The main system 802 includes a motherboard 804 having an I/O section 806, one or more central processing units (CPU) 808, and a memory section 810, which may have a flash memory card 812 related to it. The I/O section 806 can be connected to a display 814, a keyboard and/or another user input (not shown), a disk storage unit 816, and a media drive unit 818. The media drive unit 818 can read/write a computer-readable medium 820, which can contain programs 822 and/or databases. Computing system 800 can include a web browser. Moreover, it is noted that computing system 800 can be configured to include additional systems in order to fulfill various functionalities. Computing system 800 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### Additional Discussion of Online Multi-Media Micro Transactions, Interactions and Monetizations

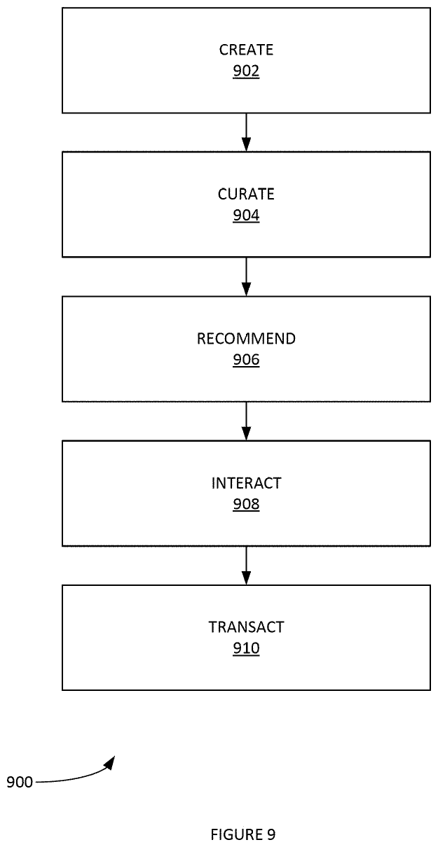

FIG. 9 illustrates an example process 900 for implementing online multi-media micro transactions, interactions and monetizations, according to some embodiments. In step 902, process 900 can implement creation steps. This can include creation of original multi-media content.

In step 904, process 900 can implement a curation step. This can be done via a closed community of Canvas creators and/or via other external sources.

In step 906, process 900 can implement a multi-media content recommendation step. This can be implemented by a multi-content recommendation system. Entities can purchase/pay for the multi-media content they wish to consume.

In step 908, process 900 can implement an interaction step. In this step, users can interact with creators of content withing the platform. This can be used to increase consumer interest. A Canvas-currency can be utilized as well.

In step 910, process 900 can implement a transaction step. This can include free multi-media content (e.g. using digital advertisements, free minutes/currency per day or month, etc.). The platform can also offer paid subscriptions. Additionally, users can gift content. As noted elsewhere, micro transaction can be implemented while the user is watching the multi-media content (e.g. can include merchandizing, etc.). It is noted that an AD system can be utilized during the transaction process.

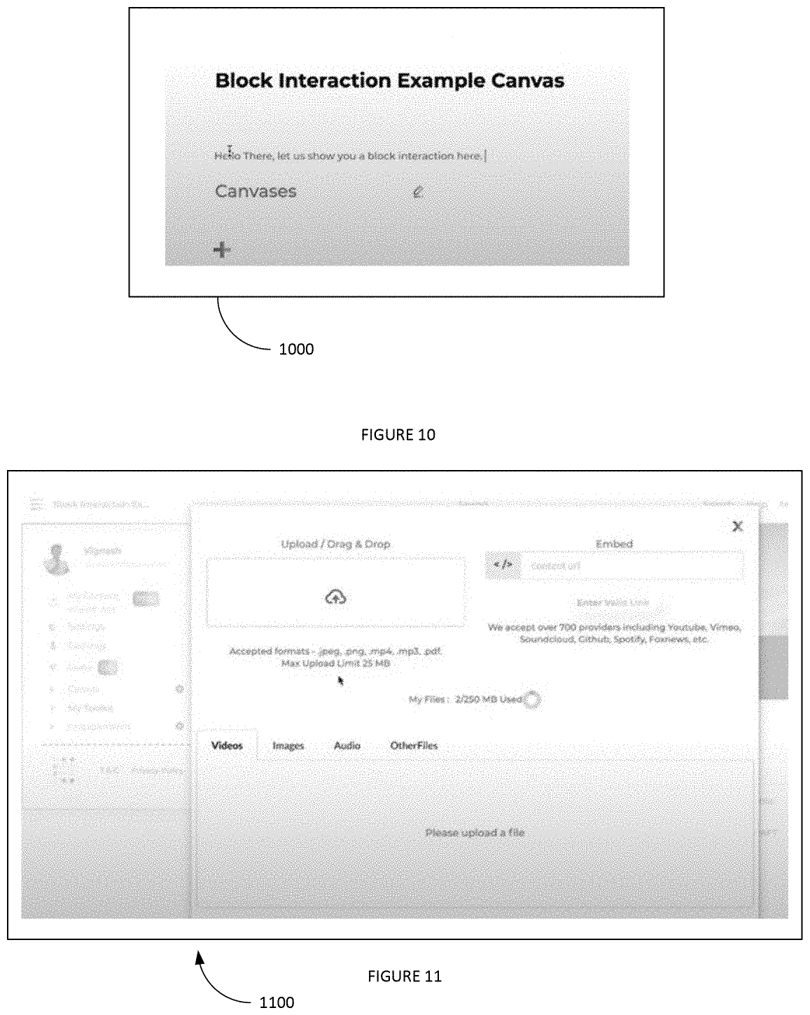

FIGS. 10-19 illustrate example screenshots of various canvas creation steps, according to some embodiments. FIG. 10 illustrates an example screenshot 1000 of a block interaction creation, according to some embodiments. It is noted that a block interaction can include a block. It is noted that a block Interaction can include, inter alia: a pay block, entire canvas lock, NFT (e.g. entire NFT and/or block, etc.), bundle as an engagement, etc.

FIG. 11 illustrates an example screenshot 1100 of an uploading operation during the block interaction creation, according to some embodiments. This operation can be used to obtain/upload the multimedia media content that is linked with the block being created. In example, a content management system of the multimedia media content platform can be used to upload a file that includes the media content.

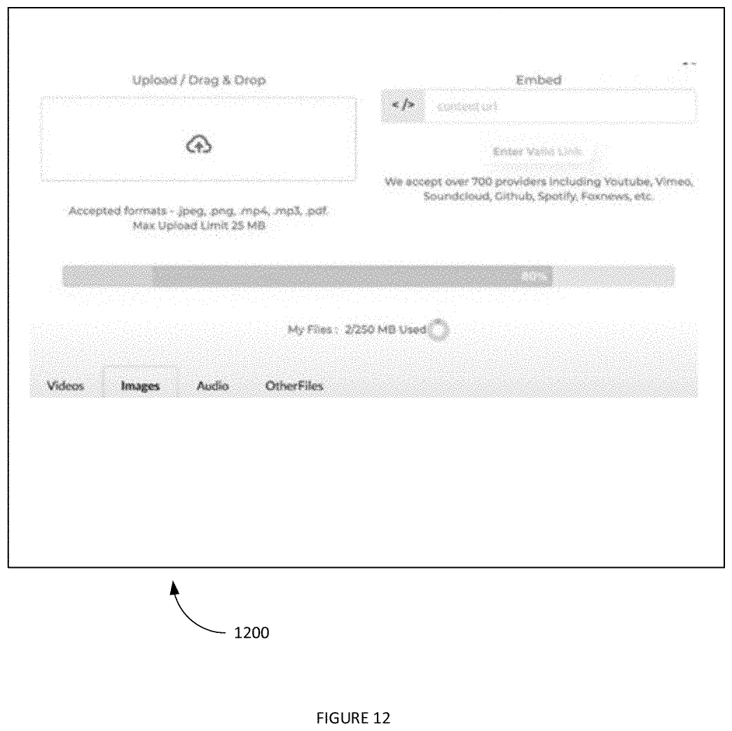

FIG. 12 illustrates an example screenshot 1200 of the uploading operation during the block interaction creation, according to some embodiments. The user interface can show that a digital image is being uploaded by the content management system. A thumbnail view of the digital image can also be gradually presented to the user as the upload operation progresses.

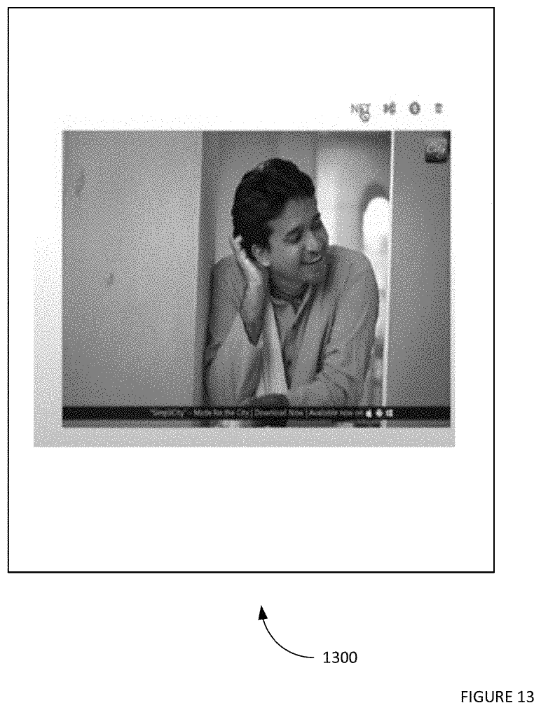

FIG. 13 illustrates an uploaded digital image 1300 that can used as the media content of a block interaction, according to some embodiments. As shown in the screen shot 1300, various virtual buttons are presented to the user. The user can press an ‘NFT’ button to generate an NFT of the digital image. This can be used to generate a pay block (e.g. see infra). The user can press an ‘block’ button to generate a block interaction of a block element in a canvas. Hyperlinks can be embedded in the block interaction. Any hyperlink across the Internet can be embedded and treated as a block. The blocked can optionally be locked. Hyperlinks from the Internet can be pushed as a block inside a canvas.

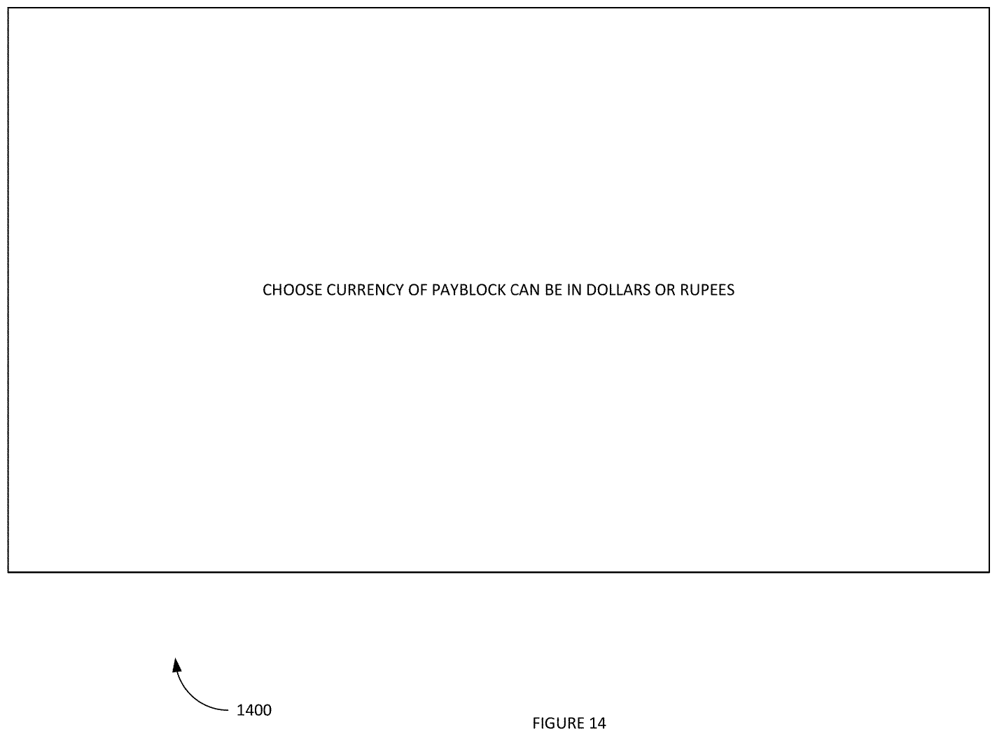

FIG. 14 illustrates an example screen shot 1400 of a pay block generation operation, according to some embodiments. As shown, a pay block can be set according to a specified geography. For example, in the United States the pay block can be set to dollars. In India, the pay block can be set to rupees. An initial NFT value can be set as well. A drop-down menu can be provided to implement these operations. A pay block can be published as a block interaction as well.

In another example, the pay block can be associated with a fiat currency in leu of an NFT.

In order to access the pay block, a user may need to pay a specified amount. In this way, the pay block creator can monetize the media content, etc. associated with the pay block.

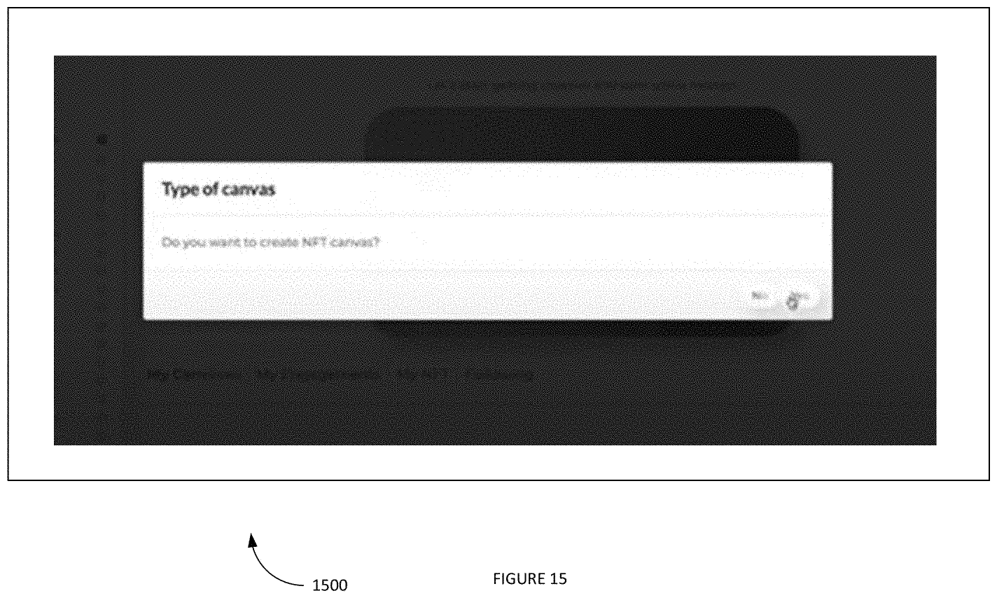

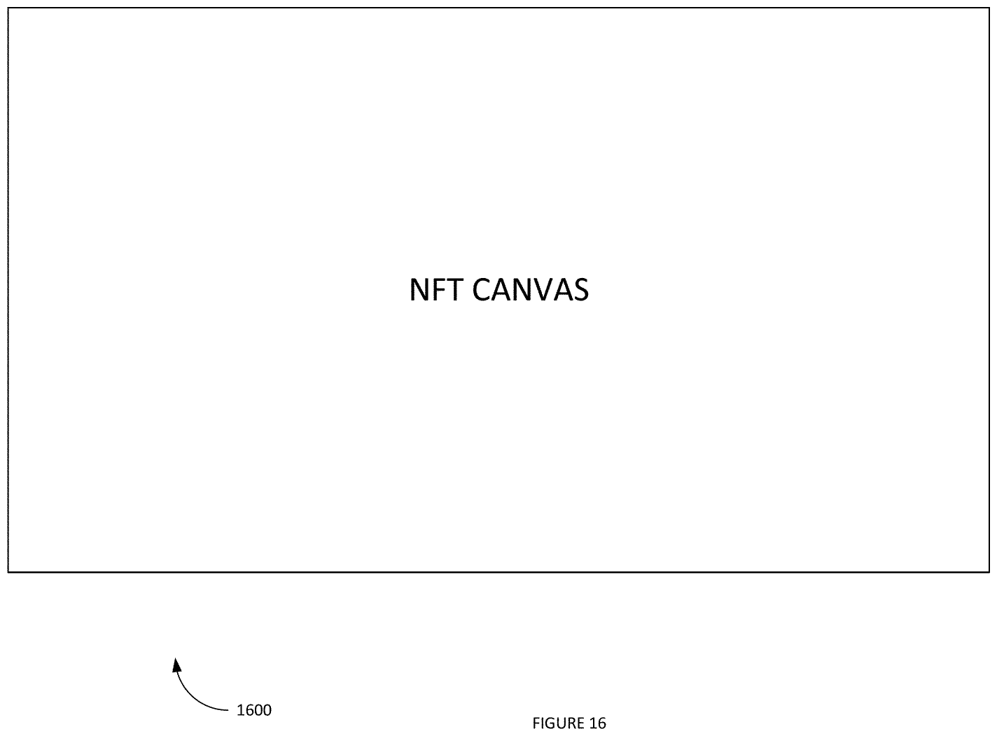

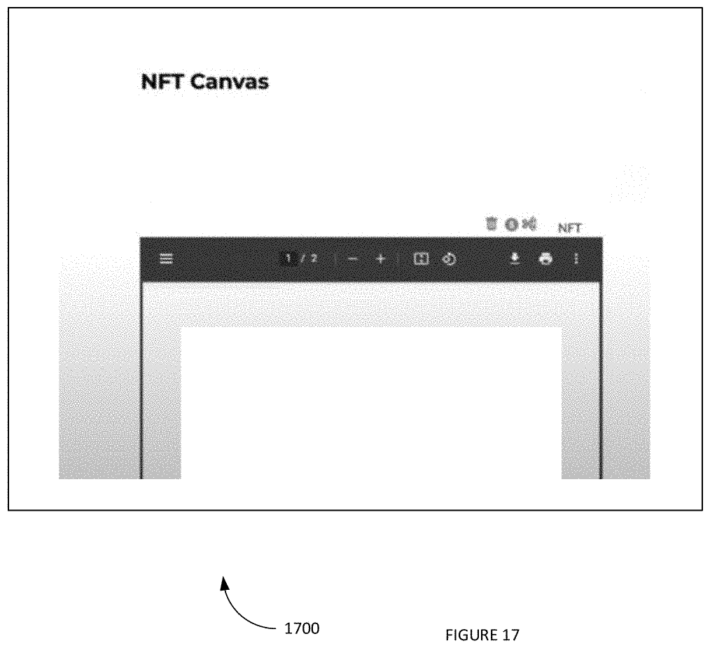

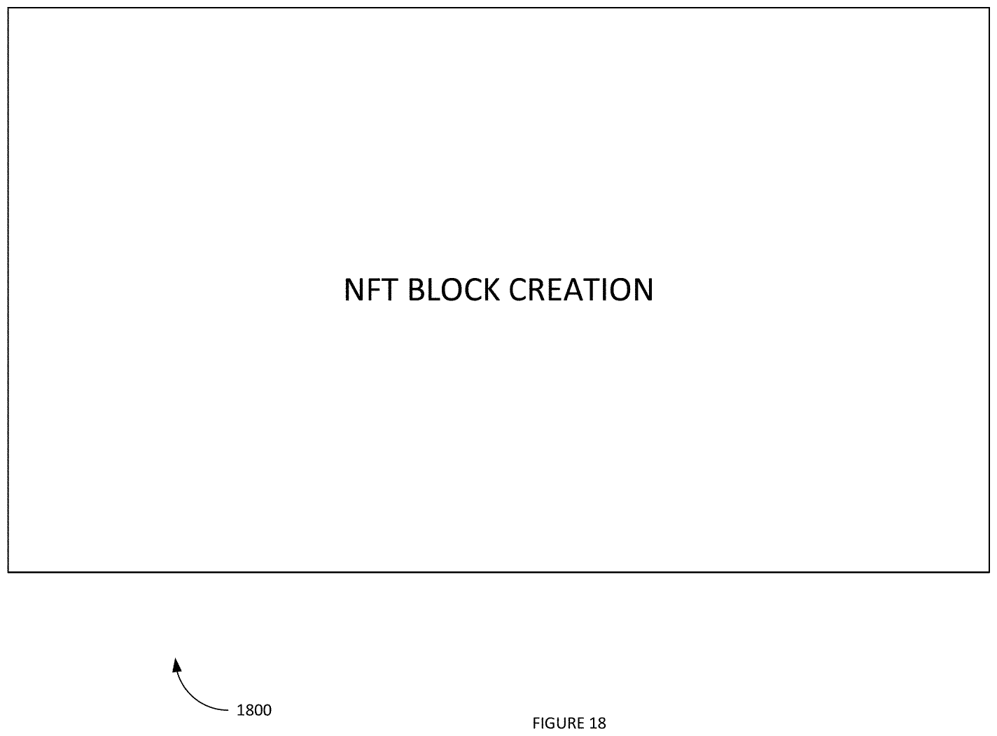

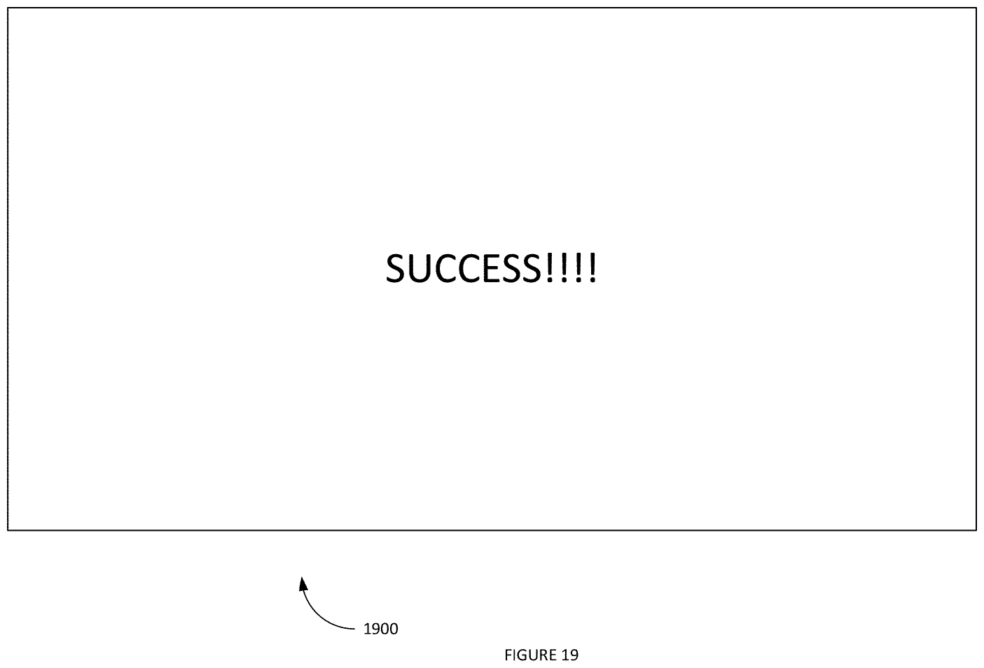

FIGS. 15 and 16 illustrate example screenshots 1500 and 1600 of a canvas generated as an NFT, according to some embodiments. In this example, an audio file can be upload (e.g. in lieu of the digital image discussed in the example supra). FIG. 17 illustrates an example interface 1700 with an NFT generation button, according to some embodiments. The NFT button can be virtually pressed and the audio file can be transformed into an NFT as shown in FIG. 18, according to some embodiments. Information about the NFT (e.g. file type, artist/creator, title, display name, etc.) can also be uploaded via interface 1700. Media teaser/preview content can also be uploaded. The NFT can be locked as well. When this information is uploaded, the NFT can be minted. The NFT is published and part of the block. It is noted that an entire canvas can be placed in an NFT state as well (e.g. as shown in FIG. 17). FIG. 19 illustrates an alert 1900 that the NFT creation has been successful.

As noted supra, a block can be a text word, text paragraph, audio, image, or a video. Each block can be pushed as fiat currency interaction (e.g. Indian rupee, U.S. dollar, etc.). Each block can be provided as an NFT. A plurality of blocks can be combined into/integrated with a larger canvas of content (e.g. a blog, web page, etc.). This large canvas of content can be pushed as a fiat currency interaction or an NFT interaction as a whole itself.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computerized method of a canvas system comprising:
providing the canvas system, wherein the canvas system comprises a multimedia media content tool and platform that provides a set of modular UI which provides micro interaction possibilities through a linear blockchain ledger and a multi-model database;
providing a set of canvas-system based media content;
organizing the canvas-system based media content in a plurality of blocks, wherein each block comprises a set of digital assets on a block level with a set of specified integrations and engagements;
with the plurality of blocks:
provide a set of block-level interactions,
nest one block into another,
put a block behind a paywall,
visually represent the blocks in different parts of the block,
create relations between a set of different blocks,
add one or more tags to each block, and
enable one or more micro-transactions for the canvas-system based media content among a plurality of users.

2. The computerized method of claim 1, wherein the multimedia media content platform allows a set of users to extract value out of content while protecting the set of creators' interests.

3. The computerized method of claim 1, wherein each block is merged into a user's home webpage.

4. The computerized method of claim 1, wherein each block comprises a parent block and a child block.

5. The computerized method of claim 1, wherein with the plurality of blocks comprises optional comments, comments under a paywall and reply to threads for different blocks;
etc.

6. The computerized method of claim 1, wherein the paywall comprises a crypto-currency based paywall services.

7. The computerized method of claim 1, wherein the canvas-system based multimedia content comprises text, audio, video, visual, performance-based content, AR/VR or any other form.

8. The computerized method of claim 1, wherein the block level comprises a word level, a paragraph level, a second level, or a pixel level.

9. The computerized method of claim 1, wherein the user interface of the multimedia media content platform comprises a set of dynamic, evolving, and intuitive elements.

10. The computerized method of claim 9, wherein the user interface of the multimedia media content platform provides a high bandwidth and a high-fidelity interface to seamlessly transfer a content creators thoughts, ideas, and concepts.

11. The computerized method of claim 10, wherein the multimedia media content platform provides a set of frictionless micro transactions of the canvas-system based media content.

12. The computerized method of claim 11, wherein the block level interactions can be implemented on any type of canvas-system based media content.

13. The computerized method of claim 12, wherein the multimedia media content platform comprises a decentralized, blockchain powered gamification platform that provides value for a time spent by a creator and a consumer for a process of consumption.

14. The computerized method of claim 13, wherein the multimedia media content platform provides a community crypto-currency.

15. The computerized method of claim 14, wherein the multimedia media content platform decentralized advertisement and multi content interaction and discovery system.

16. The computerized method of claim 15, wherein the multimedia media content platform utilizes a relational hierarchy of the canvas-system based media content.

17. The computerized method of claim 16, wherein the canvas-system based media content mimics a mental model of the creator that provides a navigation model for a consumer to navigate and absorb the canvas-system based media content.
